(19) United States
(12) Patent Application Publication
(10) Pub. No.: US 2020/0219278 A1
(43) Pub. Date: Jul. 9, 2020

(54) VIDEO GENERATING APPARATUS, VIDEO CAPTURING APPARATUS, VIDEO CAPTURING SYSTEM, VIDEO GENERATION METHOD, CONTROL PROGRAM, AND RECORDING MEDIUM

(71) Applicant: SHARP KABUSHIKI KAISHA, Sakai City, Osaka (JP)

(72) Inventors: KYOHEI IKEDA, Sakai City, Osaka (JP); YASUAKI TOKUMO, Sakai City, Osaka (JP); TOMOYUKI YAMAMOTO, Sakai City, Osaka (JP)

(21) Appl. No.: 16/648,581

(22) PCT Filed: Sep. 20, 2018
(86) PCT No.: PCT/JP2018/034844

§ 371 Date: Mar. 18, 2020

(30) Foreign Application Priority Data
Sep. 27, 2017 (JP) 2017-186852

(51) Int. Cl. G06T 7/55; H04N 5/222; G06T 7/73; G06T 19/00

(52) U.S. Cl. CPC G06T 7/55; G06T 19/00; G06T 7/74; H04N 5/2226

(57) ABSTRACT

Provided is a technique in which a three-dimensional video with no missing region can be generated even immediately after video capturing is started in an apparatus that captures an imaging object and generates a three-dimensional video of the imaging object. A video generating apparatus (1) includes a depth information obtaining unit (5) configured to obtain depth information indicating a three-dimensional shape of the display target, and a three-dimensional video generating unit (7) configured to generate the three-dimensional video with reference to the depth information and an initial reference model, which is prepared in advance before a process for generating the three-dimensional video is started and which indicates entirety of the three-dimensional shape of the display target.

### TECHNICAL FIELD

The present invention relates to a video generating apparatus that generates a three-dimensional video indicating a three-dimensional shape of a display target.

### BACKGROUND ART

As a related art, a technique called DynamicFusion is known. A main purpose of DynamicFusion is to construct a 3D model with noise being canceled in real time from a captured depth. In DynamicFusion, a depth obtained from a sensor is integrated, after deformation of a 3D shape is compensated, into a common reference model. This allows generation of a precise 3D model from a low resolution and high noise depth.

More specifically, in DynamicFusion, steps (1) to (3) below are performed.

(1) Based on an input depth (current depth) and a reference 3D model (canonical model), a camera position and a motion flow are estimated to construct a 3D model (current model).

(2) The 3D model is rendered with a viewpoint, and an updated depth is output as a reproduced depth.

(3) The 3D model constructed in (1) is integrated, after the camera position of the 3D model and the deformation of the 3D model are compensated, into the reference 3D model.

As a different example of a technique for generating a three-dimensional video, PTL 1 discloses a virtual viewpoint video apparatus. The virtual viewpoint video apparatus generates a depth map of a target object viewed from a virtual viewpoint, generates, based on the depth map, a determination image indicating whether or not the target object can be observed from multiple viewpoints, for each of pixels constituting a video of the target object captured from the virtual viewpoint, and modifies the depth map, based on the determination image.

As a different example of the technique for generating a three-dimensional video, PTL 2 discloses an object three-dimensional model reconstruction apparatus. The object three-dimensional model reconstruction apparatus generates a free-viewpoint by composing an image captured by one RGB camera and an image captured by one depth camera.

### CITATION LIST

### Patent Literature

PTL 1: JP 2015-45920 A (published on Mar. 12, 2015)

PTL 2: JP 2016-71645 A (published on May 9, 2016)

### SUMMARY OF INVENTION

### Technical Problem

By composing a reference model and a live model, based on depth information at each time point in Dynamic Fusion described above, a dynamic three-dimensional video can be created. However, in a case that the base depth information does not cover a region of an imaging object, a corresponding region in the reference model is not filled, so the three-dimensional video results in being a video with a blank in the region (for example, a face on the other side of an imaging apparatus that has obtained a depth, a part formed into a valley, or the like. Note that a region in a three-dimensional video, the region missing part of the video is referred to as a “missing region” below). Since the reference model is gradually formed by using depth information at each time point in Dynamic Fusion, the three-dimensional video immediately after video capturing is started is a video with many missing regions.

The present invention has been made in view of the above-described problems, and an object of the present invention is to provide a technique in which a three-dimensional video with no missing region can be generated even immediately after video capturing is started, in an apparatus that captures an imaging object and generates a three-dimensional video of the imaging object.

### Solution to Problem

In order to solve the above-described problem, a video generating apparatus according to an aspect of the present invention is a video generating apparatus for generating a three-dimensional video of a display target, the video generating apparatus including: a depth information obtaining unit configured to obtain depth information indicating a three-dimensional shape of the display target; and a three-dimensional video generating unit configured to generate the three-dimensional video with reference to the depth information and an initial reference model which is prepared in advance before a process for generating the three-dimensional video is started and which indicates entirety of the three-dimensional shape of the display target.

In order to solve the above-described problem, a video generation method according to an aspect of the present invention is a video generation method for generating a three-dimensional video of a display target, the video generation method including: a depth information obtaining step of obtaining depth information indicating a three-dimensional shape of the display target; and a three-dimensional video generating step of generating the three-dimensional video with reference to the depth information and an initial reference model which is prepared in advance before a process for generating the three-dimensional video is started and which indicates entirety of the three-dimensional shape of the display target.

### Advantageous Effects of Invention

According to an aspect of the present invention, it is possible, in an apparatus that captures an imaging object and generates a three-dimensional video of the imaging object, to generate a three-dimensional video with no missing region even immediately after video capturing is started.

### BRIEF DESCRIPTION OF DRAWINGS

FIG. 1 is a block diagram illustrating a configuration of a video capturing apparatus according to Embodiment 1 of the present invention.

FIG. 2 is a flowchart schematically illustrating an outline of a video generation method of a video capturing apparatus according to Embodiment 1 of the present invention.

FIG. 3 is a flowchart illustrating in more detail an initial reference model generation method illustrated in FIG. 2.

FIG. 4 is a flowchart illustrating in more detail a three-dimensional video generation method illustrated in FIG. 2.

FIG. 5 is a block diagram illustrating a configuration of a video capturing apparatus according to Embodiment 2 of the present invention.

FIG. 6 is a schematic diagram illustrating a video capturing system according to Embodiment 3 of the present invention.

FIG. 7 is a block diagram illustrating a configuration of the video capturing system according to Embodiment 3 of the present invention.

FIG. 8 is a flowchart illustrating an example of a video generation method of the video capturing system according to Embodiment 3 of the present invention.

FIG. 9 is a block diagram illustrating a configuration of a video capturing system according to Embodiment 4 of the present invention.

FIG. 10 is a flowchart illustrating an example of a video generation method of the video capturing system according to Embodiment 4 of the present invention.

FIG. 11 is a block diagram illustrating a configuration of a video capturing system according to Embodiment 5 of the present invention.

FIG. 12 is a flowchart illustrating an example of a video generation method of the video capturing system according to Embodiment 5 of the present invention.

FIG. 13 is a block diagram illustrating a configuration of a video capturing system according to Embodiment 6 of the present invention.

### DESCRIPTION OF EMBODIMENTS

Embodiments of the present invention will be described below in detail. It should be noted that each constitution described in the present embodiments is not intended to exclusively limit the scope of this invention thereto as long as there is no specific description in particular, and is merely an example for description.

### Embodiment 1

### Video Capturing Apparatus 1

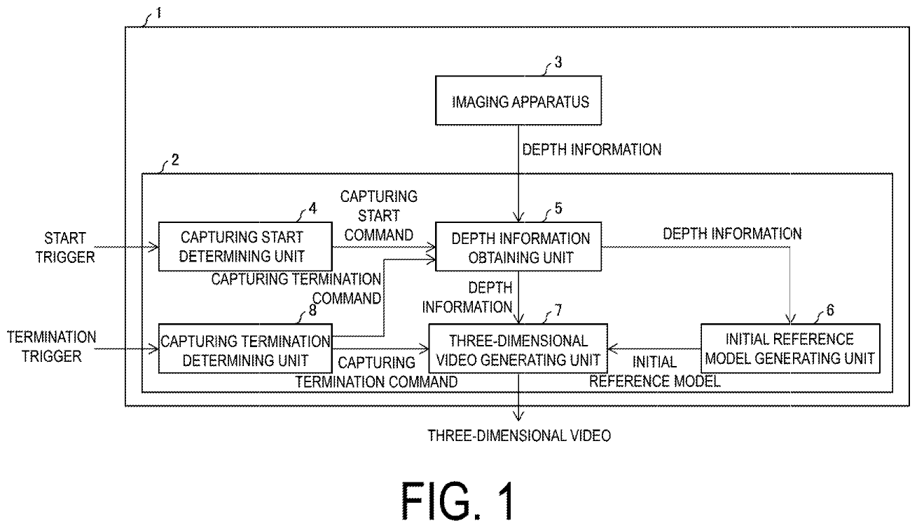

A video capturing apparatus 1 according to the present embodiment will be described in detail with reference to FIG. 1. FIG. 1 is a block diagram illustrating a configuration of the video capturing apparatus 1 according to the present embodiment. As illustrated in FIG. 1, the video capturing apparatus 1 includes a video generating apparatus 2 and an imaging apparatus 3. The video generating apparatus 2 includes a capturing start determining unit 4, a depth information obtaining unit 5, an initial reference model generating unit 6 (initial reference model generating unit), a three-dimensional video generating unit 7, and a capturing termination determining unit 8.

The imaging apparatus 3 captures a display target and generates depth information of the display target. Note that the term “display target” in the specification of the present application indicates an object captured by the imaging apparatus 3, and a three-dimensional video of which is generated by the video generating apparatus 2, based on depth information generated by the imaging apparatus 3 through the capturing. The term “depth information” in the specification of the present application indicates information related to depth from the imaging apparatus 3 to the display target, the information being derived from captured data obtained by the imaging apparatus 3 capturing the display target.

The capturing start determining unit 4 of the video generating apparatus 2 determines, by detecting a trigger to start video capturing, to start video capturing of the display target and indicates, via the depth information obtaining unit 5, the imaging apparatus 3 to start video capturing.

The depth information obtaining unit 5 obtains depth information from the imaging apparatus 3, based on the indication to start video capturing from the capturing start determining unit 4.

The initial reference model generating unit 6 composes (generates) an initial reference model with reference to the depth information obtained by the depth information obtaining unit 5. Note that the term “initial reference model” in the specification of the present application means three-dimensional model information, which is prepared in advance before a process for generating a three-dimensional video of the display target is started and which indicates an entire three-dimensional shape of the display target.

The three-dimensional video generating unit 7 generates a three-dimensional video of the display target with reference to the initial reference model generated by the initial reference model generating unit 6 and the depth information obtained by the depth information obtaining unit 5. Note that the term “three-dimensional video” in the specification of the present application refers to a video indicating a three-dimensional shape of the display target, and the video may be a still image or a video. Examples of the three-dimensional video may include a reference model, a live model generated based on the reference model and depth information immediately after being obtained, an image rendered as viewed from the position of an arbitrary viewpoint (hereinafter referred to as an “arbitrary viewpoint image”), and the like.

The capturing termination determining unit 8 determines, by detecting a trigger to terminate video capturing, to terminate the video capturing of the display target and indicates, via the depth information obtaining unit 5, the imaging apparatus 3 to terminate the video capturing.

### Video Generation Method

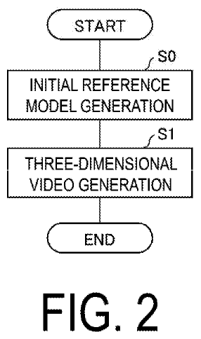

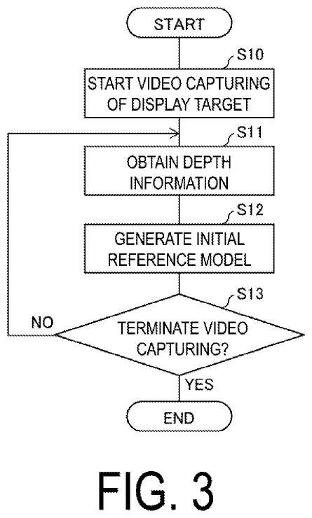

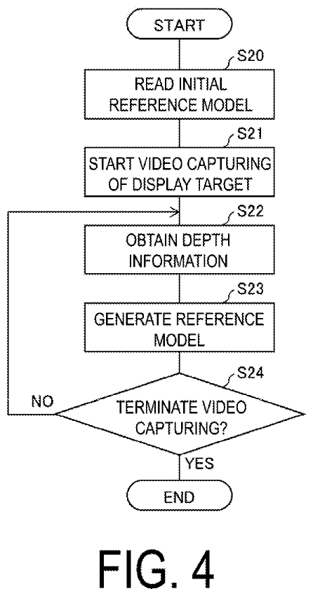

A video generation method of the video capturing apparatus 1 according to the present embodiment will be described with reference to FIGS. 2 to 4. FIG. 2 is a flowchart illustrating an outline of the video generation method of the video capturing apparatus 1 according to the present embodiment. As the outline of the video generation method of the video capturing apparatus 1 according to the present embodiment, as illustrated in FIG. 2, the video capturing apparatus 1 according to the present embodiment first generates an initial reference model (step S0) and then generates a three-dimensional video with reference to the generated initial reference model (step S1). FIG. 3 is a flowchart illustrating in more detail an initial reference model generation method illustrated in FIG. 2. FIG. 4 is a flowchart illustrating in more detail a three-dimensional video generation method illustrated in FIG. 2.

As illustrated in FIG. 3, first, in step S10, the capturing start determining unit 4 determines, by detecting the trigger to start video capturing, to start the video capturing of a display target and indicates, via the depth information obtaining unit 5, the imaging apparatus 3 to start video capturing. Moreover, in step S10, the imaging apparatus 3 captures the display target, based on an indication from the capturing start determining unit 4 and generates depth information of the display target. Note that a specific example of a method of determining start of video capturing by the capturing start determining unit 4 will be described later.

Next, the depth information obtaining unit 5 obtains depth information from the imaging apparatus 3, based on an indication to start video capturing from the capturing start determining unit 4 (step S11).

Next, the initial reference model generating unit 6 generates an initial reference model with reference to the depth information obtained by the depth information obtaining unit 5 (step S12). Note that in the present embodiment, a configuration in which the initial reference model generating unit 6 generates an initial reference model will be described. However, in the video capturing apparatus 1, an initial reference model may be generated in a different method, or may be obtained from the outside of the video capturing apparatus 1, and the method of generating or obtaining an initial reference model is not particularly limited.

Next, the capturing termination determining unit 8 determines whether or not to terminate the video capturing of the display target (step S13). In a case of determining to terminate the video capturing of the display target (YES in step S13), the capturing termination determining unit 8 indicates, via the depth information obtaining unit 5, the imaging apparatus 3 to terminate the video capturing and indicates the initial reference model generating unit 6 to terminate the generation of the initial reference model. In a case that the capturing termination determining unit 8 determines not to terminate the video capturing of the display target (NO in step S13), the process returns to step S11, and operations in step S11, step S12, and step S13 are repeated until the capturing termination determining unit 8 determines to terminate the video capturing of the display target. Note that a specific example of a method for determining termination of video capturing performed by the capturing termination determining unit 8 will be described later.

Details of three-dimensional video generation in step S1, which is the next step of the initial reference model generation in step S0 described above, will be described below with reference to FIG. 4. Note that in the three-dimensional video generation in step S1, the initial reference model generated in advance in the initial reference model generation in step S0 is used.

First, the three-dimensional video generating unit 7 reads the initial reference model generated in step S12 by the initial reference model generating unit 6 (step S20).

Next, in step S21, the capturing start determining unit 4 determines, by detecting the trigger to start video capturing, to start the video capturing of the display target and indicates, via the depth information obtaining unit 5, the imaging apparatus 3 to start video capturing. Moreover, in step S21, the imaging apparatus 3 captures the display target, based on the indication from the capturing start determining unit 4 and generates depth information of the display target.

Next, the depth information obtaining unit 5 obtains depth information from the imaging apparatus 3, based on the indication to start video capturing from the capturing start determining unit 4 (step S22).

Next, the three-dimensional video generating unit 7 generates a three-dimensional video of the display target with reference to the initial reference model read in step S20 and the depth information obtained by the depth information obtaining unit 5 (step S23). A specific example of a method in which the three-dimensional video generating unit 7 generates a three-dimensional video will be described later.

Next, the capturing termination determining unit 8 determines whether or not to terminate the video capturing of the display target (step S24). In a case of determining to terminate the video capturing of the display target (YES in step S24), the capturing termination determining unit 8 indicates, via the depth information obtaining unit 5, the imaging apparatus 3 to terminate the video capturing and indicates the three-dimensional video generating unit 7 to terminate the generation of the three-dimensional video. In a case that the capturing termination determining unit 8 determines not to terminate the video capturing of the display target (NO in step S24), the process returns to step S22, and operations in step S22, step S23, and step S24 are repeated until the capturing termination determining unit 8 determines to terminate the video capturing of the display target.

### Specific Example of Capturing Start Determination Method of Capturing Start Determining Unit 4

A specific example of a capturing start determination method of the capturing start determining unit 4 described above will be described below. As described above, in step S10 or step S21, the capturing start determining unit 4 determines, by detecting the trigger to start video capturing, to start the video capturing of the display target and indicates, via the depth information obtaining unit 5, the imaging apparatus 3 to start video capturing.

In this step, the timing at which the capturing start determining unit 4 indicates the imaging apparatus 3 to start video capturing may not necessarily be immediately after detecting the trigger to start video capturing. For example, the capturing start determining unit 4 may indicate the imaging apparatus 3 to start video capturing several seconds after detecting e trigger to start video capturing. Examples of the trigger to start video capturing detected by the capturing start determining unit 4 include pressing of a physical or electronic switch, and the like.

In a case that an imaging object (display target) and a photographer are the same in association with start of video capturing of a display target (for example, in a case of capturing himself/herself to be hereinafter referred to as an imaging-object-cum-photographer), the following problems arise. For example, it may be difficult for the imaging-object-cum-photographer to press a video capturing switch of the imaging apparatus 3 due to the imaging-object-cum-photographer and the imaging apparatus 3 being away from each other, an obstacle being present between the imaging-object-cum-photographer and the imaging apparatus 3, or the like. In a case that the imaging apparatus 3 has a configuration (timer type) for starting video capturing in a prescribed time period after the video capturing switch being pressed, the imaging apparatus 3 may capture the imaging-object-cum-photographer after pressing the video capturing switch before entering a video capturing range.

In order to solve the problems described above, in step S10 or step S21, the capturing start determining unit 4 may determine whether or not to start video capturing of the display target in the following method. For example, the imaging apparatus 3 captures the imaging object separately from the video capturing for the purpose of generating depth information in step S10 or step S21, and the capturing start determining unit 4 determines whether or not the imaging object captured by the imaging apparatus 3 has taken a particular gesture or pose. In a case of determining that the imaging object has taken the particular gesture or pose, the capturing start determining unit 4 indicates, via the depth information obtaining unit 5, the imaging apparatus 3 to start video capturing for the purpose of generating depth information.

In a different example, the imaging apparatus 3 captures the imaging object separately from the video capturing for the purpose of generating depth information in step S10 or step S21, and the capturing start determining unit 4 determines whether or not the imaging object captured by the imaging apparatus 3 has taken a particular orientation. In a case of determining that the imaging object has taken the particular orientation, the capturing start determining unit 4 indicates, via the depth information obtaining unit 5, the imaging apparatus 3 to start video capturing for the purpose of generating depth information of the imaging object.

In a different example, in step S10 or step S21, the imaging apparatus 3 obtains voice surrounding the imaging apparatus 3. With reference to voice data obtained by the imaging apparatus 3, the capturing start determining unit 4 determines whether or not voice (for example, “start” or the like) that means start of video capturing is detected. In a case of detecting voice that means start of video capturing, the capturing start determining unit 4 indicates, via the depth information obtaining unit 5, the imaging apparatus 3 to start video capturing of the imaging object.

Further, configurations combining the above examples are also included within the scope of the present embodiment. For example, in step S10 or step S21, in a case of detecting pressing of the physical or electronic switch and determining that the imaging object captured by the imaging apparatus 3 has taken the particular gesture or pose, the capturing start determining unit 4 indicates, via the depth information obtaining unit 5, the imaging apparatus 3 to start video capturing of the imaging object.

### Specific Example of Depth Information Obtaining Method of Depth Information Obtaining Unit 5

A specific example of the depth information obtaining method of the depth information obtaining unit 5 described above will be described below. As described above, in step S11 or step S22, the depth information obtaining unit 5 obtains depth information from the imaging apparatus 3, based on an indication to start video capturing from the capturing start determining unit 4. Moreover, in step S11 or step S22, the depth information obtaining unit 5 may obtain depth information generated by capturing the display target beforehand by an imaging apparatus other than the imaging apparatus 3.

In the operation in step S11 or step S22 described above, examples of the depth information obtained by the depth information obtaining unit 5 include a depth map. An example of the imaging apparatus 3 that captures the display target and generates depth information of the display target is a depth camera. Note that at least one depth camera that captures the display target and generates depth information is required, and the video generation method according to the present embodiment can be performed by using a depth map generated by one depth camera.

Different examples of the imaging apparatus 3 include an imaging apparatus that generates depth information of the display target in a Stereo matching method, an imaging apparatus that generates depth information of the display target in a Shape from silhouette method, and the like.

Specific Example of Initial Reference Model Generation Method of Initial Reference Model Generating unit 6

A specific example of the initial reference model generation method of the initial reference model generating unit 6 described above will be described below. As described above, in step S12, the initial reference model generating unit 6 generates an initial reference model with reference to the depth information obtained by the depth information obtaining unit 5.

In this step, the initial reference model generated by the initial reference model generating unit 6 is preferably a three-dimensional model that accurately reflects the three-dimensional shape of the actual imaging object (the display target). For example, the initial reference model does not have any missing region in a surface, and represents the entire three-dimensional shape of the display target. The initial reference model is preferably a three-dimensional model in which fine details of the display target are not collapsed. The initial reference model is preferably a three-dimensional model which is not an abnormally deformed three-dimensional shape (for example, in a case that the imaging object is human, the imaging object has three arms or the like).

Note that, in the present embodiment, a configuration has been described in which the imaging apparatus 3 captures the display target and generates depth information of the display target, and the initial reference model generating unit 6 generates an initial reference model with reference to the depth information. However, the initial reference model may be generated in a different method or may be obtained from the outside of the video capturing apparatus 1, and the method of generating or the method of obtaining an initial reference model is not particularly limited.

For example, an imaging apparatus other than the imaging apparatus 3 may capture the display target and generate depth information of the display target, and the initial reference model generating unit 6 may generate an initial reference model with reference to the depth information. Alternatively, a video capturing apparatus other than the video capturing apparatus 1 may capture the display target, generate depth information of the display target, and generate an initial reference model with reference to the depth information. In this case, the video capturing apparatus I generates a three-dimensional video of the display target with reference to the initial reference model generated by the video capturing apparatus other than the video capturing apparatus 1.

The imaging apparatus 3 may capture the imaging object and generate color information (an RGB image or the like) of the imaging object (the display target). In this case, the initial reference model generating unit 6 may add the color information to the initial reference model generated with reference to the depth information.

### Specific Example of Three-Dimensional Video Generation Method of Three-Dimensional Video Generating Unit 7

A specific example of the three-dimensional video generation method of the three-dimensional video generating unit 7 described above will be described below. As described above, in step S23, the three-dimensional video generating unit 7 generates a three-dimensional video of the display target with reference to the initial reference model and the depth information. Examples of the three-dimensional video here include a reference model, as live model, an arbitrary viewpoint image, and the like. Further, in this step, examples of a method in which the three-dimensional video generating unit 7 generates a three-dimensional video include a method using the technique of Dynamic Fusion described above.

More specifically, in step S23, the three-dimensional video generating unit 7 configures the read initial reference model as a current reference model. In addition, every time depth information is obtained from the depth information obtaining unit 5, the three-dimensional video generating unit 7 updates the three-dimensional video (the reference model, the live model, the arbitrary viewpoint image, or the like) of the display target with reference to the depth information (integrates the latest depth information with the three-dimensional video).

In this step, for example, the three-dimensional video generating unit 7 may rotate the generated reference model in a certain manner and then output the rotated reference model. In a case that the three-dimensional video generating unit 7 updates the reference model, the live model, and the arbitrary viewpoint image with reference to the depth information, the updating of the reference model, the live model, and the arbitrary viewpoint image need not necessarily be performed every time depth information is obtained. The three-dimensional video generating unit 7 may output, after the update of the reference model, the live model, and the arbitrary viewpoint image, (a frame image of) a three-dimensional video based on the reference model, the live model, and the arbitrary viewpoint image thus updated.

In a case of determining that the depth information most recently obtained from the depth information obtaining unit 5 negatively affects the generation of the three-dimensional video (such as a reference model), the three-dimensional video generating unit 7 need not update the three-dimensional video. An example of a case that the three-dimensional video generating unit 7 does not update the three-dimensional video in step S23 will be described below.

For example, in a case that the depth information (current depth information) most recently obtained from depth information obtaining unit 5 and depth information (previous depth information) obtained from the depth information obtaining unit 5 before the current depth information is obtained are extremely different from each other, the three-dimensional video generating unit 7 does not update the three-dimensional video, based on the current depth information.

In a different example, in a case of determining that the current depth information includes strong noise, the three-dimensional video generating unit 7 does not update the three-dimensional video, based on the current depth information.

In a different example, the three-dimensional video generating unit 7 compares the current depth information and the previous depth information. In a case that an object that is not present in the previous depth information is present in the current depth information, the three-dimensional video generating unit 7 does not update the three-dimensional video, based on the current depth information.

The three-dimensional video generating unit 7 may obtain color information (color, gray scale, or the like) of the display target (imaging object) along with depth information, and update the three-dimensional video with reference to the depth information and the color information. The three-dimensional video generated in this way is a video in which the color information of the display target is reflected.

### Specific Example of Capturing Termination Determination Method of Capturing Termination Determining Unit 8

A specific example of a capturing termination determination method of the capturing termination determining unit 8 described above will be described below. As described above, in step S13 or step S24, the capturing termination determining unit 8 determines whether or not to terminate the video capturing of the display target.

In this step, for example, the capturing termination determining unit 8 determines, by detecting the trigger to terminate video capturing, to terminate the video capturing of the display target. In such a configuration, the timing at which the capturing termination determining unit 8 indicates the imaging apparatus 3 to terminate video capturing may not necessarily be immediately after detecting the trigger to terminate video capturing. For example, the capturing termination determining unit 8 may indicate the imaging apparatus 3 to terminate the video capturing, several seconds after detecting the trigger to terminate video capturing. Examples of the trigger to terminate video capturing detected by the capturing termination determining unit 8 include pressing of a physical or electronic switch, and the like. In such an example, the capturing termination determining unit 8 determines, by detecting pressing of the physical or electronic switch, to terminate the video capturing of the display target.

As in the capturing start determination method performed by the capturing start determining unit 4 described above, the capturing termination determining unit 8 may determine, by detecting the trigger involving no switch to terminate video capturing, to terminate the video capturing of the display target. Such examples are given below. For example, the capturing termination determining unit 8 determines whether or not the imaging object captured by the imaging apparatus 3 has taken a particular gesture or pose. In a case of determining that the imaging object has taken the particular gesture or pose, the capturing termination determining unit 8 indicates, via the depth information obtaining unit 5, the imaging apparatus 3 to terminate the video capturing and to the three-dimensional video generating unit 7 to terminate the generation of the three-dimensional video.

In a different example, in step S13 or step S24, the capturing termination determining unit 8 determines whether or not the imaging object captured by the imaging apparatus 3 has taken a particular orientation. In a case of determining that the imaging object has taken the particular orientation, the capturing termination determining unit 8 indicates, via the depth information obtaining unit 5, the imaging apparatus 3 to terminate the video capturing and indicates the three-dimensional video generating unit 7 to terminate the generation of the three-dimensional video.

In a different example, in step S13 or step S24, in a case of determining that the imaging object captured by the imaging apparatus 3 has rotated n times, the capturing termination determining unit 8 indicates, via the depth information obtaining unit 5, the imaging apparatus 3 to terminate the video capturing and indicates the three-dimensional video generating unit 7 to terminate the generation of the three-dimensional video.

In a different example, in step S24, in a case of determining that part of the reference model indicated by the depth information is integrated at a certain or higher percentage with a surface of the reference model or the like generated by the three-dimensional video generating unit 7, the capturing termination determining unit 8 indicates, via the depth information obtaining unit 5, the imaging apparatus 3 to terminate the video capturing and indicates the three-dimensional video generating unit 7 to terminate the generation of the three-dimensional video.

In a different example, in step S24, in a case of determining that the three-dimensional video generating unit 7 no longer updates the reference model, the capturing termination determining unit 8 indicates, via the depth information obtaining unit 5, the imaging apparatus 3 to terminate the video capturing and indicates the three-dimensional video generating unit 7 to terminate the generation of the three-dimensional video,

In a different example, in step S13 or step S24, the imaging apparatus 3 obtains voice surrounding the imaging apparatus 3. With reference to voice data obtained by the imaging apparatus 3, the capturing termination determining unit 8 determines whether or not voice (for example, “stop” or the like) that means termination of video capturing is detected. In a case of detecting voice meaning termination of video capturing, the capturing termination determining unit 8 indicates, via the depth information obtaining unit 5, the imaging apparatus 3 to terminate the video capturing and indicates the three-dimensional video generating unit 7 to terminate the generation of the three-dimensional video.

Further, configurations combining the above examples are also included within the scope of the present embodiment. For example, in step S13 or step S24, in a case of detecting pressing of the physical or electronic switch and determining that the imaging object captured by the imaging apparatus 3 has taken the particular gesture or pose, the capturing termination determining unit 8 indicates, via the depth information obtaining unit 5, the imaging apparatus 3 to terminate the video capturing and indicates the three-dimensional video generating unit 7 to terminate the generation of the three-dimensional video.

### Supplement

As described above, the video generating apparatus 2 included in the video capturing apparatus 1 according to the present embodiment obtains depth information indicating a three-dimensional shape of the display target, and generates a three-dimensional video of the display target with reference to the depth information and the initial reference model which is prepared in advance before the process for generating the three-dimensional video is started and which indicates the entire three-dimensional shape of the display target.

According to the above-described configuration, a three-dimensional video is generated with reference to an initial reference model, which is prepared in advance before the process for generating the three-dimensional video is started and which indicates the entire three-dimensional shape of the display target, and hence it is possible to generate a three-dimensional video with no missing region, even immediately after video capturing is started.

Moreover, the video generating apparatus 2 included in the video capturing apparatus 1 according to the present embodiment generates an initial reference model with reference to obtained depth information, and generates a three-dimensional video of the display target with reference to the initial reference model.

According to the above-described configuration, it is possible to generate an initial reference model in advance in an apparatus for generating a three-dimensional video, and to generate a three-dimensional video with no missing region with reference to the initial reference model.

### Embodiment 2

In the video capturing apparatus 1 according to Embodiment 1 described above, it is preferable in some cases to perform video capturing (pre-capturing) for obtaining depth information to serve as a basis of an initial reference model and video capturing (capturing of a three-dimensional video) for obtaining depth information to serve as a basis of a three-dimensional video, with a temporal difference. In addition, performing pre-capturing for the same imaging object (display target) for each capturing of a three-dimensional video requires time and work.

In some cases, the location where capturing of a three-dimensional video is performed and the location where pre-capturing is performed are different from each other. An example of such a case is, for example, a case in which pre-capturing is performed in a studio, and then, after move to a filming location, capturing of a three-dimensional video is performed. A different example is a case in which, after pre-capturing is performed and depth information of a dynamic imaging object is obtained once, capturing of a three-dimensional video (and generation of a three-dimensional video) is performed at a destination to which the depth information and an initial reference model generated based on the depth information are transmitted.

In each case as described above, a video capturing apparatus capable of generating a three-dimensional video with reference to depth information and an initial reference model is desired. Thus, a video generating apparatus 11 included in a video capturing apparatus 10 according to the present embodiment stores an initial reference model and generates a three-dimensional video of a display target with reference to the stored initial reference model.

Embodiment 2 of the present invention as described above will be described with reference to the drawings. Note that members having the same functions as the members included in the video capturing apparatus 1 described in Embodiment 1 are denoted by the same reference signs, and descriptions thereof will be omitted.

### Video Capturing Apparatus 10

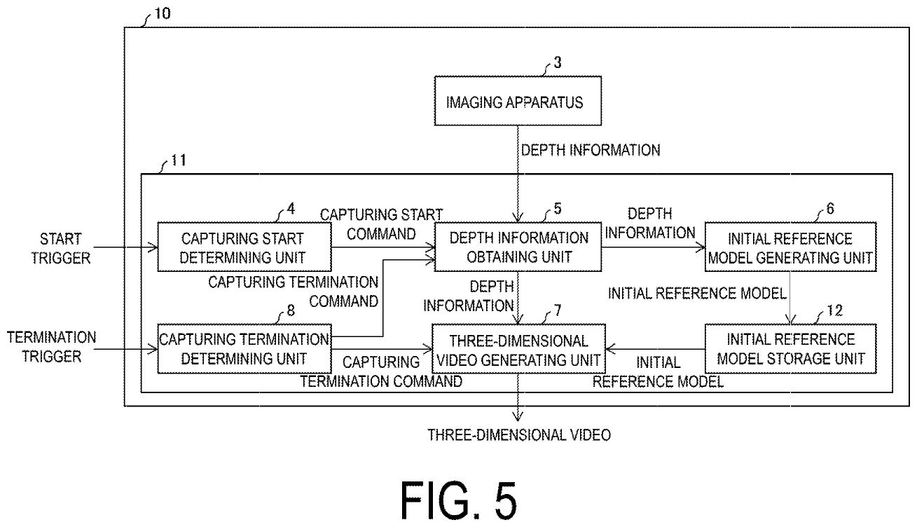

The video capturing apparatus 10 according to the present embodiment will be described with reference to FIG. 5. FIG. 5 is a block diagram illustrating a configuration of the video capturing apparatus 10 according to the present embodiment. As illustrated in FIG. 5, the video capturing apparatus 10 includes the video generating apparatus 11 and the imaging apparatus 3. The video generating apparatus 11 has a similar configuration to that of the video generating apparatus 2 according to Embodiment 1 except that the video generating apparatus 11 further includes an initial reference model storage unit 12. The initial reference model storage unit 12 stores an initial reference model generated by the initial reference model generating unit 6.

### Video Generation Method

A video generation method of the video capturing apparatus 10 according to the present embodiment will be described. Note that the video generation method of the video capturing apparatus 10 according to the present embodiment is similar to the video generation method according to Embodiment 1 except that a new step is added next to step S13 described above and that step S20 is different. Hence, detailed descriptions of steps similar to those in the video generation method according to Embodiment 1 are omitted.

In the video generation method according to the present embodiment, as the next step of step S13 described above, the initial reference model storage unit 12 stores an initial reference model generated by the initial reference model generating unit 6. Note that, as a modified example of the present embodiment, the initial reference model storage unit 12 may obtain an initial reference model from the outside of the video capturing apparatus 10 and store the initial reference model.

In step S20 described above, the three-dimensional video generating unit 7 reads the initial reference model stored in the initial reference model storage unit 12. In this step, the three-dimensional video generating unit 7 may select one initial reference model from among initial reference models stored by the initial reference model storage unit 12. In this case, the three-dimensional video generating unit 7 may read an initial reference model selected by a user from among the initial reference models stored in the initial reference model storage unit 12. The three-dimensional video generating unit 7 may select, from among the initial reference models stored in the initial reference model storage unit 12, an initial reference model similar to an object configured as the imaging object.

In step S24 described above, in a case that the capturing termination determining unit 8 determines to terminate the video capturing of the display target, the initial reference model storage unit 12 may store, as an initial reference model, the three-dimensional video (such as the reference model) generated by the three-dimensional video generating unit 7 in step S23. This step may be performed in a case of receiving, from a user, an input indicating to store the three-dimensional video as an initial reference model.

### Supplement

As described above, the video generating apparatus 11 included in the video capturing apparatus 10 according to the present embodiment stores an initial reference model and generates a three-dimensional video of a display target with reference to the stored initial reference model.

According to the above-described configuration, it is possible to generate a three-dimensional video with no missing region with reference to a stored initial reference model. Moreover, since a three-dimensional video can be generated with reference to a stored initial reference model, video capturing for obtaining depth information to serve as a basis of the initial reference model and video capturing for obtaining depth information to serve as a basis of the three-dimensional video need not be performed consecutively. For an imaging object video capturing of which for obtaining depth information to serve as a basis of an initial reference model is performed once, it is not necessary to perform the video capturing again. Since video capturing for obtaining depth information to serve as a basis of an initial reference model and video capturing for obtaining depth information to serve as a basis of the three-dimensional video need not be performed consecutively, the video capturing for each purpose can be performed in a different place.

### Embodiment 3

The video capturing apparatus 1 according to Embodiment 1 or the video capturing apparatus 10 according to Embodiment 2 described above captures a moving imaging object (display target), obtains depth information of the imaging object, and generates a three-dimensional video with reference to the depth information. A specific example of such a configuration is, for example, a method of generating a three-dimensional video with reference to depth information at each time point, based on Dynamic Fusion described above. However, in such a technique, in a case that a user of the video capturing apparatus 1 or the video capturing apparatus 10 is an ordinary user, the user does not know how to perform video capturing in order to obtain a three-dimensional video in which the actual three-dimensional shape of an imaging object is reflected.

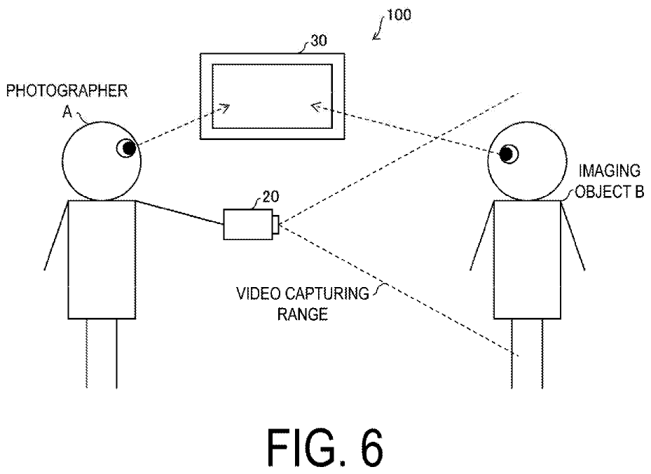

In order to solve the problem described above, in the present embodiment, a video capturing system 100 illustrated in FIG. 6 is used. FIG. 6 is a schematic diagram illustrating the video capturing system 100 according to the present embodiment. In the video capturing system 100 illustrated in FIG. 6, a video capturing apparatus 20 operated by a photographer A captures an imaging object B (display target) and generates capturing indication information related to video capturing of the imaging object B. A capturing indication output apparatus 30 outputs an indication related to the video capturing of the display target with reference to the capturing indication information generated by the video capturing apparatus 20. Embodiment 3 of the present invention as described above will be described below with reference to the drawings.

### Video Capturing System 100

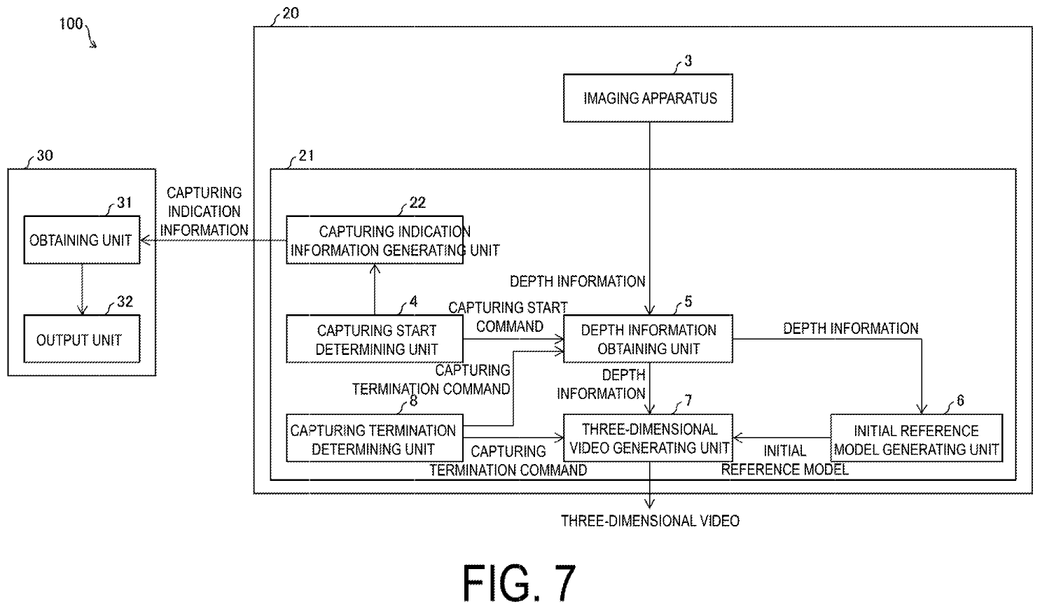

The video capturing system 100 according to the present embodiment will be described with reference to FIG. 7. FIG. 7 is a block diagram illustrating a configuration of the video capturing system 100 according to the present embodiment. As illustrated in FIG. 7, the video capturing system 100 includes the video capturing apparatus 20 and the capturing indication output apparatus 30. The video capturing apparatus 20 includes a video generating apparatus 21 and the imaging apparatus 3. The video generating apparatus 21 has a similar configuration to that of the video generating apparatus 2 according to Embodiment 1 except that the video generating apparatus 21 further includes a capturing indication information generating unit 22. Hence, members having the same functions as the members included in the video capturing apparatus 1 described in Embodiment 1 are denoted by the same reference signs, and descriptions thereof will be omitted. The capturing indication output apparatus 30 includes an obtaining unit 31 and an output unit 32.

The capturing indication information generating unit 22 included in the video generating apparatus 21 generates capturing indication information related to video capturing of the display target by the imaging apparatus 3. The capturing indication information generated by the capturing indication information generating unit 22 will be described later.

The obtaining unit 31 included in the capturing indication output apparatus 30 obtains the capturing indication information generated by the capturing indication information generating unit 22. The output unit 32 outputs an indication related to the video capturing of the display target with reference to the capturing indication information obtained by the obtaining unit 31. Examples of the capturing indication output apparatus 30 include a monitor for outputting as a video an indication related to video capturing of the display target, a speaker for outputting as voice or sound an indication related to video capturing of the display target, and the like.

### Video Generation Method

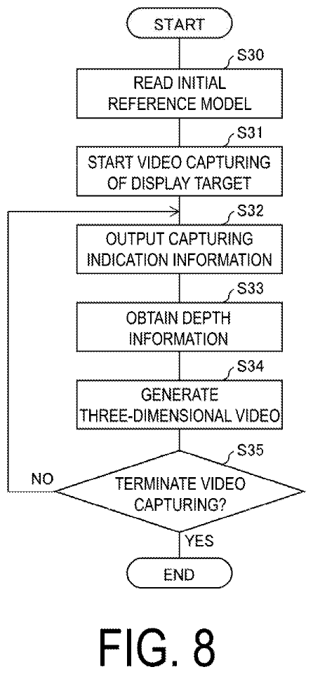

A video generation method of the video capturing system 100 according to the present embodiment will be described in detail with reference to FIG. 8. FIG. 8 is a flowchart illustrating an example of the video generation method of the video capturing system 100 according to the present embodiment. Note that a method of generating and outputting capturing indication information in the video generation method according to the present embodiment is similarly applicable to the process of initial reference model generation in step S0 described in Embodiment 1 (the operations in step S10 to step S13) and the process of three-dimensional video generation in step S1 (the operations in step S20 to step S24). Therefore, a description of a process corresponding to the process of initial reference model generation in step S0, in the video generation method according to the present embodiment will be omitted, and a mode in which the method of generating and outputting capturing indication information is applied to the process of three-dimensional video generation in step S1 will be described below. Detailed descriptions of similar steps to those in the video generation method according to Embodiment 1 are omitted,

First, as illustrated in FIG. 8, the three-dimensional video generating unit 7 reads an initial reference model generated by the initial reference model generating unit 6 (step S30).

Next, in step S31, the capturing start determining unit 4 determines, by detecting the trigger to start video capturing, to start the video capturing of the display target and indicates, via the depth information obtaining unit 5, the imaging apparatus 3 to start video capturing. Moreover, in step S31, the imaging apparatus 3 starts capturing the display target, based on an indication from the capturing start determining unit 4 (and, along with this, starts generating depth information of the display target).

Next, in step S32, the capturing indication information generating unit 22 generates capturing indication information related to video capturing of the display target by the imaging apparatus 3, based on the indication of start of the video capturing from the capturing start determining unit 4. In step S32, the obtaining unit 31 of the capturing indication output apparatus 30 obtains the capturing indication information generated by the capturing indication information generating unit 22, and the output unit 32 of the capturing indication output apparatus 30 outputs an indication related to the video capturing of the display target with reference to the capturing indication information obtained by the obtaining unit 31.

Examples of the above “indication related to video capturing of the display target” include an indication to guide the user of the video capturing apparatus 20 to adjust the video capturing apparatus 20 to an optimal orientation or position, an indication to guide the user of the video capturing apparatus 20 to change the configuration of conditions of the video capturing apparatus 20 for video capturing to optimal configuration, and the like. With reference to the indication thus output from the output unit 32, the user (the photographer A described above) of the video capturing apparatus 20 is able to adjust the orientation or position of the video capturing apparatus 20 with respect to the imaging object (the display target, the imaging object B described above), configuration of conditions (brightness, focus, or the like) of the video capturing apparatus 20 for video capturing.

As a next step of step S32, the depth information obtaining unit 5 obtains depth information generated as a result of video capturing of the imaging object by the imaging apparatus 3 of the video capturing apparatus 20 adjusted by the user as described above (step S33).

Next, the three-dimensional video generating unit 7 generates a three-dimensional video of the display target with reference to the initial reference model read in step S30 and the depth information obtained by the depth information obtaining unit 5 (step 534).

Next, the capturing termination determining unit 8 determines whether or not to terminate the video capturing of the display target (step S35). In a case of determining to terminate the video capturing of the display target (YES in step S35), the capturing termination determining unit 8 indicates, via the depth information obtaining unit 5, the imaging apparatus 3 to terminate the video capturing and indicates the three-dimensional video generating unit 7 to terminate the generation of the three-dimensional video. In a case that the capturing termination determining unit 8 determines not to terminate the video capturing of the display target (NO in step S35), the process returns to step S32, and operations in step 532, step S33, step S34, and step 535 are repeated until the capturing termination determining unit 8 determines to terminate the video capturing of the display target.

### Specific Examples of Capturing Indication Information Generated by Capturing Indication Information Generating Unit 22

Specific examples of the capturing indication information generated by the capturing indication information generating unit 22 described above will be described below. As described above, in step S32, the capturing indication information generating unit 22 generates capturing indication information related to video capturing of the display target by the imaging apparatus 3, based on the indication of the start of the video capturing from the capturing start determining unit 4. In step S32, the obtaining unit 31 of the capturing indication output apparatus 30 obtains the capturing indication information generated by the capturing indication information generating unit 22, and the output unit 32 of the capturing indication output apparatus 30 outputs an indication related to the video capturing of the display target with reference to the capturing indication information obtained by the obtaining unit 31.

In the above steps, for example, the capturing indication information generating unit 22 generates capturing indication information indicating an operation or behavior the user needs to take in order to obtain depth information necessary to generate a suitable reference model. The output unit 32 of the capturing indication output apparatus 30 outputs an indication with reference to the capturing indication information. Note that the target of the indication output by the output unit 32 of the capturing indication output apparatus 30 may be the photographer, the imaging object, or both. Note that, in each of the examples below, an example is given in which the photographer and the imaging object are human.

As described above, in order to obtain depth information necessary to generate a preferable reference model, the following conditions are to be satisfied. For example, the imaging apparatus 3 included in the video capturing apparatus 20 needs to capture the entire surface of the imaging object. In a different example, motion of the imaging object needs to be slow to such an extent that the imaging object in captured data obtained by video capturing by the imaging apparatus 3 does not appear blurred.

An example of an indication output from the output unit 32 of the capturing indication output apparatus 30 with reference to the capturing indication information generated by the capturing indication information generating unit 22 is an indication to the imaging object (display target). More specifically, the indication may be, for example, an indication to guide the imaging object to rotate, an indication to guide the imaging object to take a particular pose, an indication to guide the imaging object to face a particular direction, an indication to guide the imaging object so that the position of the imaging object relative to the video capturing apparatus 20 moves to a particular position, an indication to guide the imaging object to slow down the speed of the motion (move slowly), or the like.

A different example of the indication output from the output unit 32 of the capturing indication output apparatus 30 with reference to the capturing indication information generated by the capturing indication information generating unit 22 is an indication to the photographer (the user of the video capturing apparatus 20). More specifically, this indication may be, for example, an indication to guide the photographer to move around the imaging object, an indication to guide the photographer to tilt the video capturing apparatus 20 or change the orientation of the video capturing apparatus 20, an indication to guide the photographer to provide an indication to the imaging object (for example, an indication to guide the photographer to read aloud an indication (such as letters) to the imaging object), an indication to guide the photographer to change the configuration of the video capturing apparatus 20, or the like.

The capturing indication information generating unit 22 may generate capturing indication information before the capturing start determining unit 4 indicates start of video capturing in step S31, and the output unit 32 of the capturing indication output apparatus 30 may output an indication related to the video capturing of the display target with reference to the capturing indication information.

An example of an indication to the imaging object will be described below, the indication being output from the output unit 32 with reference to the capturing indication information generated by the capturing indication information generating unit 22 before the capturing start determining unit 4 indicates start of video capturing. For example, this indication may be an indication to guide the imaging object to face a particular direction, an indication to provide a procedure for obtaining a three-dimensional shape of the imaging object, an indication to guide the imaging object to move out from a video capturing range in order to obtain depth information of only a background without the imaging object, an indication to guide the imaging object so that the position of the imaging object relative to the video capturing apparatus 20 moves to a particular position, or the like.

An example of an indication to the photographer will be described below, the indication being output from the output unit 32 with reference to the capturing indication information generated by the capturing indication information generating unit 22 before the capturing start determining unit 4 indicates start of video capturing. For example, this indication may be an indication to guide the photographer to keep an optical axis of the imaging apparatus 3 horizontal, an indication to guide the photographer to direct a light-receiving surface of the imaging apparatus 3 toward the imaging object, an indication to guide the photographer to change the orientation of the imaging apparatus 3, an indication to guide the photographer to provide an indication to the imaging object (for example, an indication to guide the photographer to read aloud an indication (such as letters) to the imaging object), an indication to guide the photographer to change the configuration of the video capturing apparatus 20, or the like.

In a case that the output unit 32 of the capturing indication output apparatus 30 is a monitor, the output unit 32 may display the current three-dimensional video (such as a reference model) generated by the three-dimensional video generating unit 7 in step S34, in addition to the indication indicated by the capturing indication information. As a result, the photographer can perform video capturing for obtaining depth information of the imaging object while checking the generated three-dimensional video.

In each of the examples described above, an example of the case in which the photographer and the imaging object are human, has been described. The following describes an example of a case in which a subject of video capturing (corresponding to the aforementioned photographer, hereinafter referred to as video capturing equipment) and an imaging object is electronic equipment will be described. In a case of such an example, in step S32 described above, the capturing indication information generating unit 22 generates capturing indication information indicating a control signal for controlling the operation of the electronic equipment, and the video capturing equipment or the imaging object performs particular operations with reference to the capturing indication information.

For example, the video capturing equipment may be movable equipment (for example, a drone, or the like) to which the video capturing apparatus 20 is attached. In this example, in step S32, the capturing indication information generating unit 22 generates capturing indication information indicating a control signal for controlling the operation of the equipment, to control the equipment to capture the imaging object with reference to the capturing indication information while moving around the imaging object. In this way, it is possible to capture, for example, an imaging object not capable of hearing an indication (for example, a baby or an animal). It is also possible to capture, for example, an imaging object that is fixed and is hence not capable of moving.

In a different example, the imaging object may be an object placed on a rotatable stage (rotary stage). In this example, in step S32, the capturing indication information generating unit 22 generates capturing indication information indicating a control signal for controlling rotation of the rotary stage, to control the rotary stage to rotate a stage with reference to the capturing indication information.

### Modifications

In the video capturing system 100 according to the present embodiment, the video capturing apparatus 20 captures the display target and generates capturing indication information related to the video capturing of the display target. The capturing indication output apparatus 30 outputs an indication related to the video capturing of the display target with reference to the capturing indication information generated by the video capturing apparatus 20. However, this configuration also has the following problems.

For example, an imaging object indicated by the capturing indication output apparatus 30 to move slowly intends to move slowly but actually move faster than originally intended in some cases. In this case, the video capturing apparatus 20 may not be able to generate a preferable reference model. In a different example, in a case that an imaging object happens to move out of the video capturing range of the video capturing apparatus 20 while moving, the video capturing apparatus 20 is not able to obtain depth information of the imaging object and is thus not able to subsequently generate any three-dimensional video (for example, a reference model or the like). In a case that there is a region for which corresponding depth information is not obtained by the video capturing apparatus 20 among regions of a surface of the imaging object in a three-dimensional video, the three-dimensional video results in having a region to he a missing region.

To solve the problems described above, in step S32, the capturing indication information generating unit 22 may analyze depth information previously obtained by he depth information obtaining unit 5 and generate capturing indication information with reference to a result of the analysis. Alternatively, the capturing indication information generating unit 22 may analyze a three-dimensional video (for example, a reference model or the like) previously generated by the three-dimensional video generating unit 7 and generate capturing indication information with reference to a result of the analysis.

In such a configuration described above, for example, the capturing indication information generating unit 22 analyzes depth information previously obtained by the depth information obtaining unit 5. In a case of detecting that the video capturing apparatus 20 or the imaging object is operating at a high speed, the capturing indication information generating unit 22 generates capturing indication information including an indication to guide the photographer or the imaging object to slow down the movement.

In a different example, for example, in a case of analyzing depth information previously obtained by the depth information obtaining unit 5 and detecting that the position of the imaging object has been shifted, the capturing indication information generating unit 22 generates capturing indication information indicating an indication to guide the imaging object to return to the original position.

In a different example, for example, the capturing indication information generating unit 22 analyzes the depth information previously obtained by the depth information obtaining unit 5 and generates capturing indication information that issues a warning in a case that an object other than the imaging object appears in the capturing range of the imaging apparatus 3.

In a different example, for example, the capturing indication information generating unit 22 analyzes a three-dimensional video (for example, a reference model or the like) previously generated by the three-dimensional video generating unit 7, searches the surface of the imaging object in the three-dimensional video for a missing region, and generates capturing indication information including an indication to guide the imaging object to direct the region corresponding to the missing region toward the video capturing apparatus 20.

The present embodiment also includes a configuration in which the method of generating and outputting capturing indication information in the video generation method according to the present embodiment is applied to the process of the video capturing apparatus 20 generating an initial reference model, which is a process corresponding to step S0 described in Embodiment 1 above. In this configuration, after the step corresponding to step S10 (start of video capturing) described above, capturing indication information related to video capturing of the display target by the imaging apparatus 3 is generated based on indication to start video capturing from the capturing start determining unit 4. The capturing indication information generating unit 22 may analyze the initial reference model previously generated by the initial reference model generating unit 6, and generate capturing indication information with reference to a result of the analysis.

### Supplement

As described above, the video generating apparatus 21 included in the video capturing apparatus 20 according to the present embodiment generates capturing indication information related to the video capturing of the display target by the imaging apparatus 3.

According to the configuration described above, it is possible, by providing an indication to a photographer or an imaging object (display target) by appropriately using capturing indication information, to preferably capture the imaging object and is consequently easier to obtain necessary depth information. Hence, a three-dimensional video with no missing region is easily generated.

The video capturing apparatus 20 according to the present embodiment may generate the capturing indication information with reference to at least one or more of depth information, an initial reference model, and a three-dimensional video.

According to the above-described configuration, it is possible to generate capturing indication information according to a state of the imaging object (display target), based on at least one or more of the depth information, the initial reference model, and the three-dimensional video. By providing an indication to a photographer or an imaging object (display target) while appropriately using the capturing indication information thus generated, it is possible to perform video capturing according to a state of the imaging object and is consequently easier to obtain necessary depth information. Hence, a three-dimensional video with no missing region is easily generated.

### Embodiment 4

Embodiment 1, Embodiment 2, and Embodiment 3 described above have the following problems arise. For example, the configuration for capturing start determination by the capturing start determining unit 4 and the configuration for capturing termination determination by the capturing termination determining unit 8 are not suitable for a state of video capturing in some cases. More specifically, for example, there may be a case in which pressing of a switch is a trigger to start video capturing video capturing termination in an environment where the photographer is not able to press the switch.

In a case that a range of a display target (the area of a surface of the display target or the distance to the display target) for which the depth information obtaining unit 5 obtains depth is not appropriately configured, an object other than the imaging object may be included in a three-dimensional video (a reference model or the like), or a portion of the imaging object may not be included in the three-dimensional video. In addition, generating a three-dimensional video in which the three-dimensional shape of the imaging object is reflected is difficult based only on depth information generated by the imaging apparatus 3 in some cases.

In order to solve the problems described above, a video capturing apparatus 40 according to the present embodiment configures at least one or more of an initial condition related to start or termination of video capturing of a display target by the imaging apparatus 3, an initial condition related to obtaining of depth information by the depth information obtaining unit 5, and an initial condition related to generation of a three-dimensional video by the three-dimensional video generating unit 7. Embodiment 4 of the present invention as described above will be described below with reference to the drawings.

### Video Capturing System 101

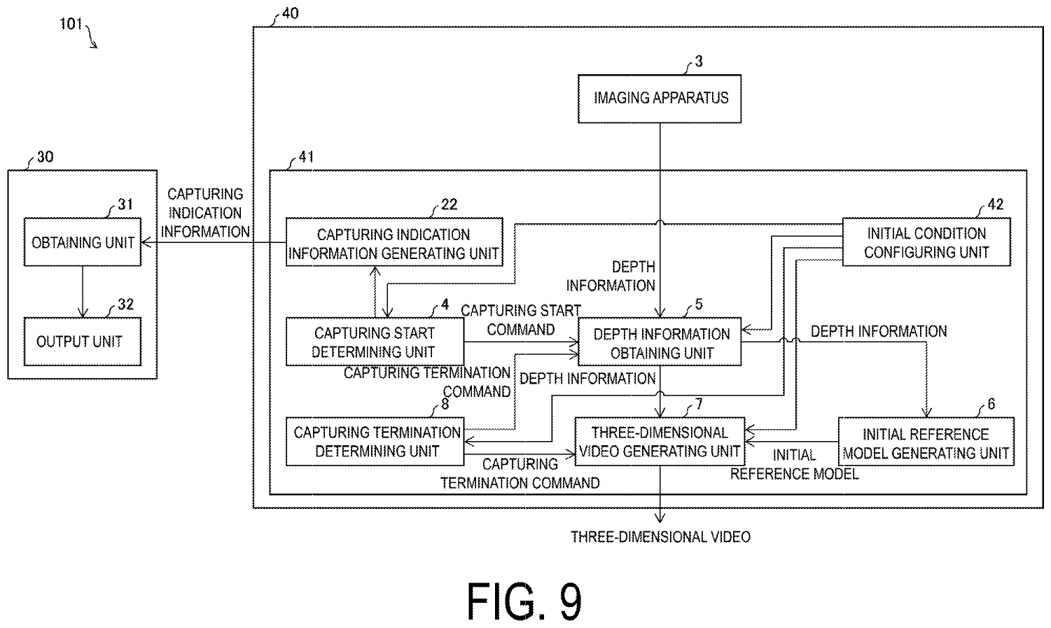

A video capturing system 101 according to the present embodiment will be described with reference to FIG. 9. FIG. 9 is a block diagram illustrating a configuration of the video capturing system 101 according to the present embodiment. As illustrated in FIG. 9, the video capturing system 101 includes a video capturing apparatus 40 and the capturing indication output apparatus 30. The video capturing apparatus 40 includes a video generating apparatus 41 and the imaging apparatus 3. The video generating apparatus 41 has a similar configuration to that of the video generating apparatus 21 according to Embodiment 3 except that the video generating apparatus 41 further includes an initial condition configuring unit 42. Hence, members having the same functions as the members included in the video capturing system 100 described in Embodiment 3 (including the members included in the video capturing apparatus 1 described in Embodiment 1) are denoted by the same reference signs, and descriptions thereof will be omitted.

The initial condition configuring unit 42 configures at least one or more of an initial condition related to start or termination of video capturing of a display target by the imaging apparatus 3 (an initial condition related to determination of capturing start by the capturing start determining unit 4 or an initial condition related to determination of capturing termination by the capturing termination determining unit 8), an initial condition related to obtaining of depth information by the depth information obtaining unit 5, and an initial condition related to composing (generation) of a three-dimensional video by the three-dimensional video generating unit 7.

### Video Generation Method

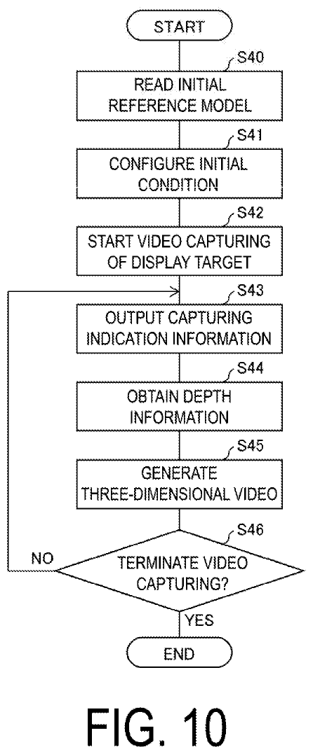

A video generation method by the video capturing system 101 according to the present embodiment will be described in detail with reference to FIG. 10. FIG. 10 is a flowchart illustrating an example of the video generation method of the video capturing system 101 according to the present embodiment. Note that an initial condition configuration method in the video generation method according to the present embodiment is similarly applicable to the process of initial reference model generation in step S0 described in Embodiment 1 (the operations in step S10 to step S13) and the process of three-dimensional video generation in step S1 (the operations in step S20 to step S24). Therefore, descriptions of a process corresponding to the process of an initial reference model generation in step S0, in the video generation method according to the present embodiment will be omitted, and a mode in which the initial condition configuration method is applied to the process of three-dimensional video generation in step S1 will be described below. Detailed descriptions of similar steps to those in the video generation method according to Embodiment 1 or similar steps to those in the video generation method according to Embodiment 3 are omitted.

First, as illustrated in FIG. 10, the three-dimensional video generating unit 7 reads an initial reference model generated by the initial reference model generating unit 6 (step S40).

Next, the initial condition configuring unit 42 configures at least one or more of an initial condition related to start or termination of video capturing of a display target by the imaging apparatus 3 (an initial condition related to determination of capturing start by the capturing start determining unit 4 or an initial condition related to determination of capturing termination by the capturing termination determining unit 8), an initial condition related to obtaining of depth information by the depth information obtaining unit 5, and an initial condition related to composing (generation) of a three-dimensional video by the three-dimensional video generating unit 7 (step S41). An initial condition configured by the initial condition configuring unit 42 here may be an initial condition selected by the initial condition configuring unit 42 or may be an initial condition selected by the user of the video capturing apparatus 40.

Next, in step S42, the capturing start determining unit 4 determines to start video capturing of a display target according to the initial condition configured by the initial condition configuring unit 42 and indicates, via the depth information obtaining unit 5, the imaging apparatus 3 to start video capturing. Moreover, in step S42, the imaging apparatus 3 starts capturing the display target, based on an indication from the capturing start determining unit 4 (and, along with this, starts generating depth information of the display target).

Next, in step S43, the capturing indication information generating unit 22 generates capturing indication information related to video capturing of the display target by the imaging apparatus 3, based on the indication of start of video capturing from the capturing start determining unit 4. In step S43, the obtaining unit 31 of the capturing indication output apparatus 30 obtains the capturing indication information generated by the capturing indication information generating unit 22, and the output unit 32 of the capturing indication output apparatus 30 outputs an indication related to the video capturing of the display target with reference to the capturing indication information obtained by the obtaining unit 31.

Next, the depth information obtaining unit 5 obtains depth information generated as a result of capturing the imaging object by the imaging apparatus 3 of the video capturing apparatus 20, according to the initial condition configured by the initial condition configuring unit 42 (step S44).

Next, the three-dimensional video generating unit 7 generates a three-dimensional video of the display target with reference to the initial reference model read in step S40 and the depth information obtained by the depth information obtaining unit 5, according to the initial condition configured by the initial condition configuring unit 42 (step S45).

Next, the capturing termination determining unit 8 determines whether or not to terminate the video capturing of the display target, according to the initial condition configured by the initial condition configuring unit 42 (step S46). In a case of determining to terminate the video capturing of the display target (YES in step S46), the capturing termination determining unit 8 indicates, via the depth information obtaining unit 5, the imaging apparatus 3 to terminate the video capturing and indicates the three-dimensional video generating unit 7 to terminate the generation of the three-dimensional video. In a case that the capturing termination determining unit 8 determines not to terminate the video capturing of the display target (NO in step S46), the process returns to step S43, and operations in step S43, step S44, step S45, and step S46 are repeated until the capturing termination determining unit 8 determines to terminate the video capturing of the display target.

### Specific Examples of Initial Condition(s) Configured by Initial Condition Configuring Unit 42

Specific examples of the initial condition(s) configured by the initial condition configuring unit 42 described above will be described below. As described above, in step S41, the initial condition configuring unit 42 configures at least one or more of an initial condition related to start or termination of video capturing of a display target by the imaging apparatus 3 (an initial condition related to determination of capturing start by the capturing start determining unit 4 or an initial condition related to determination of capturing termination by the capturing termination determining unit 8), an initial condition related to obtaining of depth information by the depth information obtaining unit 5, and an initial condition related to composing (generation) of a three-dimensional video by the three-dimensional video generating unit 7.

In the above step, for example, the initial condition configuring unit 42 configures an initial condition for specifying at least one capturing start method described in Embodiment 1 (Specific Example of Capturing Start Determination Method of Capturing Start Determining Unit 4), as a capturing start method performed by the capturing start determining unit 4. In step S42, the capturing start determining unit 4 determines to start video capturing of a display target by the at least one capturing start method, according to the initial condition and indicates, via the depth information obtaining unit 5, the imaging apparatus 3 to start video capturing.

In a different example, the initial condition configuring unit 42 configures an initial condition for specifying at least one capturing termination method described in Embodiment 1 (Specific Example of Capturing Termination Determination Method of Capturing Termination Determining Unit 8), as a capturing termination method performed by the capturing termination determining unit 8. In step S46 described above, the capturing termination determining unit 8 determines whether or not to terminate the video capturing of the display target according to the initial condition by the at least one capturing termination method and indicates, via the depth information obtaining unit 5, the imaging apparatus 3 to terminate the video capturing and indicates the three-dimensional video generating unit 7 to terminate the generation of the three-dimensional video.

In a different example, the initial condition configuring unit 42 configures an initial condition specifying a depth range to be obtained by the depth information obtaining unit 5 (for example, depths in a prescribed range relative to the position of the imaging apparatus 3). Then, in step S44 described above, the depth information obtaining unit 5 obtains only the depths included in the range specified by the initial condition.

In a different example, the initial condition configuring unit 42 configures an initial condition in which an object that is within a video capturing range but is not the imaging object is specified as a target for which the depth information obtaining unit 5 is to obtain depth information. In step S44 described above, the depth information obtaining unit 5 obtains only the depth information of the object specified by the initial condition.

In a different example, the initial condition configuring unit 42 configures an initial condition for specifying a parameter to be referred to by the three-dimensional video generating unit 7 to generate a three-dimensional video. In step S45 described above, the three-dimensional video generating unit 7 generates, with reference to the initial reference model and the depth information, a three-dimensional video by using the parameter specified by the initial condition.

In a different example, the initial condition configuring unit 42 configures an initial condition for specifying a base model of a three-dimensional video in which the three-dimensional shape of the imaging object is accurately reflected, to be referred to by the three-dimensional video generating unit 7 to generate a three-dimensional video. In step S45 described above, the three-dimensional video generating unit 7 generates, with reference to the initial reference model and the depth information, a three-dimensional video while checking the three-dimensional video with the base model specified by the initial condition.

In a different example, an imaging object is human, and the initial condition configuring unit 42 configures an initial condition for specifying characteristics (for example, height, gender, the type of clothes (wearing a skirt or not, wearing loose clothes, or the like), or the like) of the imaging object to be referred by the three-dimensional video generating unit 7 to generate a three-dimensional video. In step S45 described above, the three-dimensional video generating unit 7 generates a three-dimensional video with reference to the initial reference model, the depth information, and the characteristics of the imaging object specified by the initial condition.

In a different example, the initial condition configuring unit 42 configures an initial condition for specifying a range in which the imaging apparatus 3 captures a video (for example, the whole body or the upper half of the body of human, or the like). The imaging apparatus 3 captures the range specified by the initial condition.

In a different example, the initial condition configuring unit 42 configures an initial condition for specifying a method of checking a state of a three-dimensional video in Embodiment 5 to be described later.

### Supplement

As described above, the video capturing apparatus 40 according to the present embodiment configures at least one or more of an initial condition related to start or termination of video capturing of a display target by the imaging apparatus 3, an initial condition related to obtaining of depth information by the depth information obtaining unit 5, and an initial condition related to generation of a three-dimensional video by the three-dimensional video generating unit 7 (a three-dimensional video generating unit in claims).

According to the above-described configuration, by appropriately configuring an initial condition(s), it is possible to preferably perform video capturing of a display target, obtaining of depth information, or generation of a three-dimensional video. More specifically, for example, by appropriately configuring an initial condition(s) related to start of video capturing or termination of video capturing of the display target, it is possible to select a video capturing start trigger or a video capturing termination trigger suitable for a state of video capturing. Similarly, by appropriately configuring, as the initial condition, a parameter related to generation of a three-dimensional video, it is possible to generate a more preferable three-dimensional video. Similarly, by appropriately configuring, as an initial condition, a parameter that makes a three-dimensional video to be generated closer to the three-dimensional shape of the imaging object in generating of the three-dimensional video, it is possible to generate a three-dimensional video in which the three-dimensional shape of the imaging object is reflected more accurately.

### Embodiment 5

Embodiments 1 to 4 described above have the following problem. For example, in a case that a three-dimensional video generated by the three-dimensional video generating unit 7 has a problem and the imaging apparatus 3 performs video capturing again, the depth information obtained previously is not used and is wasted. In order to solve the problem described above, the video capturing apparatus 50 according to the present embodiment checks, with reference to a generated three-dimensional video, the state of the three-dimensional video. Embodiment 5 of the present invention described above will be described below with reference to the drawings.

### Video Capturing System 102

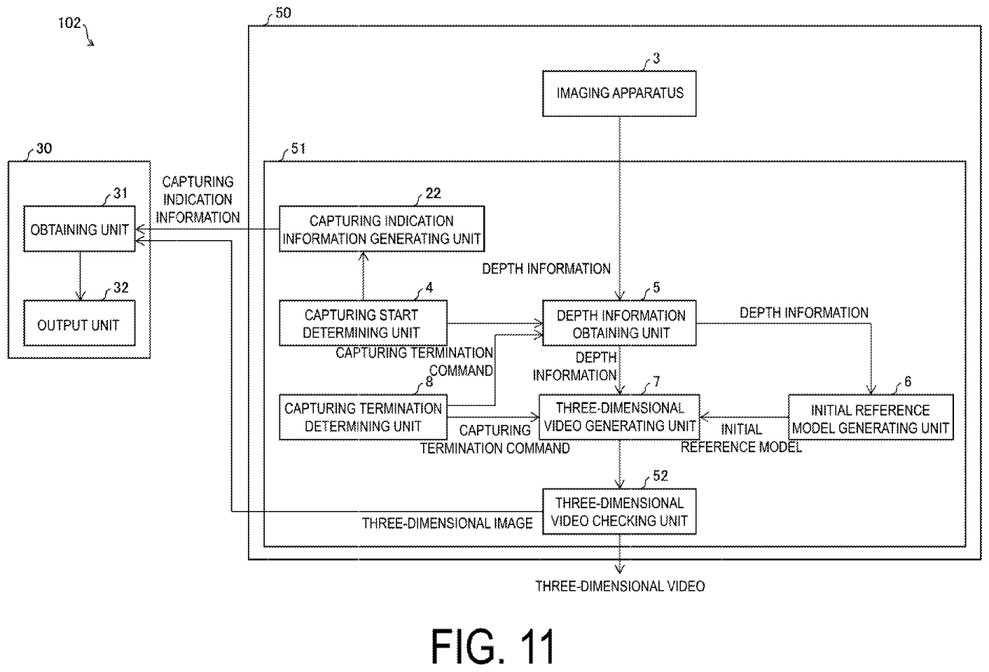

A video capturing system 102 according to the present embodiment will be described with reference to FIG. 11. FIG. 11 is a block diagram illustrating a configuration of the video capturing system 102 according to the present embodiment. As illustrated in FIG. 11, the video capturing system 102 includes a video capturing apparatus 50 and the capturing indication output apparatus 30. The video capturing apparatus 50 includes the imaging apparatus 3 and a video generating apparatus 51. The video generating apparatus 51 has a similar configuration to that of the video generating apparatus 21 according to Embodiment 3 except that the video generating apparatus 51 further includes a three-dimensional video checking unit 52. Hence, members having the same functions as the members included in the video capturing system 100 described in Embodiment 3 (including the members included in the video capturing apparatus 1 described in Embodiment 1) are denoted by the same reference signs, and descriptions thereof will be omitted.

With reference to the three-dimensional video generated by the three-dimensional video generating unit 7, the three-dimensional video checking unit 52 checks the state of the three-dimensional video.

### Video Generation Method

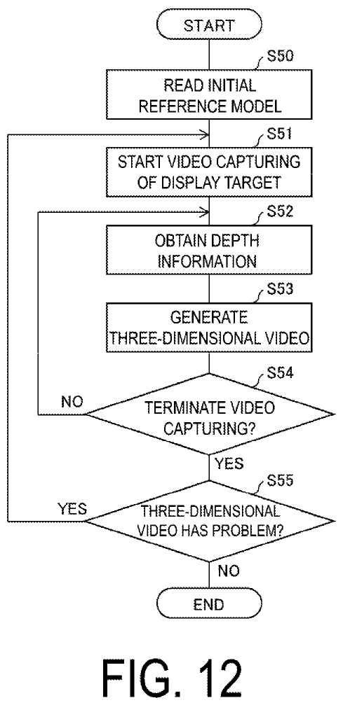

A video generation method by the video capturing system 102 according to the present embodiment will be described in detail with reference to FIG. 12. FIG. 12 is a flowchart illustrating an example of the video generation method of the video capturing system 102 according to the present embodiment. Note that a three-dimensional video checking method in the video generation method according to the present embodiment is similarly applicable to the process of initial reference model generation in step S0 described in Embodiment 1 (the operations in step S10 to step S13) and the process of three-dimensional video generation in step S1 (the operations in step S20 to step S24). Therefore, descriptions of a process corresponding to the process of initial reference model generation in step S0, in the video generation method according to the present embodiment will be omitted, and a mode in which the three-dimensional video checking method is applied to the process of three-dimensional video generation in step S1 will be described below. Detailed descriptions of similar steps to those in the video generation method according to Embodiment 1 or similar steps to those in the video generation method according to Embodiment 3 are omitted.

First, as illustrated in FIG. 12, the three-dimensional video generating unit 7 reads an initial reference model generated by the initial reference model generating unit 6 (step S50).

Next, in step S51, the capturing start determining unit 4 determines, by detecting the trigger to start video capturing, to start the video capturing of the display target and indicates, via the depth information obtaining unit 5, the imaging apparatus 3 to start video capturing. Moreover, in step S51, the imaging apparatus 3 starts capturing the display target, based on an indication from the capturing start determining unit 4 (and, along with this, starts generating depth information of the display target).

Next, the depth information obtaining unit 5 obtains depth information generated as a result of capturing the imaging object by the imaging apparatus 3 of the video capturing apparatus 20 (step S52).

Next, the three-dimensional video generating unit 7 generates a three-dimensional video of the display target with reference to the initial reference model read in step S50 and the depth information obtained by the depth information obtaining unit 5 (step S53).

Next, the capturing termination determining unit 8 determines whether or not to terminate the video capturing of the display target (step S54). In a case of determining to terminate the video capturing of the display target (YES in step S54), the capturing termination determining unit 8 indicates, via the depth information obtaining unit 5, the imaging apparatus 3 to terminate the video capturing and indicates the three-dimensional video generating unit 7 to terminate the generation of the three-dimensional video, and the process proceeds to step S55. In a case that the capturing termination determining unit 8 determines not to terminate the video capturing of the display target (NO in step S54), the process returns to step S52, and operations in step S52, step S53, and step S54 are repeated until the capturing termination determining unit 8 determines to terminate the video capturing of the display target.

In step S55, the three-dimensional video checking unit 52 checks the three-dimensional video which the three-dimensional video generating unit 7 has terminated to generate, and determines whether or not the three-dimensional video has any problem. In a case that the three-dimensional video checking unit 52 determines that the three-dimensional video has a problem (YES in step S55), the process returns to step S51, and the steps of step S51, step S52, step S53, and step S54 are repeated until the three-dimensional video checking unit 52 determines that three-dimensional video does not have any problem. In a case that the three-dimensional video checking unit 52 determines that the three-dimensional video does not have any problem (NO in step S55), the three-dimensional video is output to the outside of the video capturing apparatus 50.

### Specific Example of Three-Dimensional Video Checking Method of Three-Dimensional Video Checking Unit 52

A specific example of the three-dimensional video checking method of the three-dimensional video checking unit 52 described above will be described below. As described above, in step S55, the three-dimensional video checking unit 52 checks the three-dimensional video which the three-dimensional video generating unit 7 has terminated to generate, and determines whether or not the three-dimensional video has any problem.

In the above-described step, for example, the three-dimensional video checking unit 52 outputs a three-dimensional video to the capturing indication output apparatus 30 (which may be different equipment), and causes the output unit 32 of the capturing indication output apparatus 30 to output the three-dimensional video. Such a configuration may be employed in which the user of the video capturing apparatus 50 determines whether or not the three-dimensional video output from the output unit 32 has any problem, and the three-dimensional video checking unit 52 obtains a result of the determination to determine whether or not the three-dimensional video has any problem. In this configuration, the user may be able to select whether to further update the current three-dimensional video or cancel the current three-dimensional video.

In the above-described configuration, for example, a configuration may be further added in which the user can rotate or move the three-dimensional video output from the output unit 32. Alternatively, the configuration may be further added in which the user can cause the imaging object in the three-dimensional video output from the output unit 32, to take a specified pose. Alternatively, in this configuration, a configuration may be further added in which the user can cause the imaging object in the three-dimensional video output from the output unit 32, to take the same pose as the imaging object at the checking of the three-dimensional model. Alternatively, in this configuration, a configuration may be further added in which the capturing indication output apparatus 30 automatically estimates a problematic part of a three-dimensional model (for example, a part including a missing region, a part having an abnormal shape, and the like), and the output unit 32 displays the part so as to stand out.

In a different example, for example, the three-dimensional video checking unit 52 checks the three-dimensional video which the three-dimensional video generating unit 7 has terminated to generate, and automatically estimates the degree of completion of the three-dimensional video, to determine whether or not the three-dimensional video has any problem. In this configuration, for example, the three-dimensional video checking unit 52 determines whether or not the imaging object (human) in the three-dimensional video has an abnormal shape in comparison with a human body model, to determine whether or not the three-dimensional video has any problem. Alternatively, in this configuration, for example, the three-dimensional video checking unit 52 determines whether or not a surface of the reference model (three-dimensional video) is filled at a certain percentage or higher (determines whether or not a missing region(s) occupies the surface at a certain percentage), to determine whether or not the three-dimensional video has any problem,

As described above, in a case that the three-dimensional video checking unit 52 determines that the three-dimensional video has a problem (YES in step S55), the process returns to step S51, and the steps of step S51, step S52, step S53, and step S54 are repeated until the three-dimensional video checking unit 52 determines that three-dimensional video does not have any problem. More specifically, for example, in a case that the three-dimensional video checking unit 52 determines that the three-dimensional video has a problem (for example, a case that the reference model (three-dimensional video) has a shape far away from the imaging object), the three-dimensional video generating unit 7 cancels the generated three-dimensional video and generates a three-dimensional video again with reference to the depth information generated by the imaging apparatus 3 capturing the display target again. In a different example, in a case that the three-dimensional video checking unit 52 determines that a portion of the three-dimensional video has a problem, the imaging apparatus 3 captures only a portion of the imaging object corresponding to the portion and generates depth information. Then, the three-dimensional video generating unit 7 modifies the three-dimensional video with reference to the depth information. In a different example, in a case that the three-dimensional video checking unit 52 determines that a portion of the three-dimensional video has a problem, the output unit 32 of the capturing indication output apparatus 30 provides candidates for (a part of) a reference model for complementing the portion, to the user. The three-dimensional video generating unit 7 modifies the three-dimensional video with reference to a model selected by the user (i.e., modifies the three-dimensional video by using an existing model without performing video capturing again).

### Supplement

As described above, the video capturing apparatus according to the present embodiment checks, with reference to a generated three-dimensional video, the state of the three-dimensional video.

According to the above-described configuration, by checking the state of a generated three-dimensional video, it is possible to appropriately exclude a three-dimensional video having a missing region(s). In a case that a three-dimensional video has a problem and the display target is to be captured again, continuously updating the three-dimensional video previously generated makes it possible to reduce the time taken for the operation as compared to a case where video capturing is performed from scratch.

### Embodiment 6

Embodiments 1 to 5 described above have the following problem. For example, in a case that obtaining of depth information and generating of a three-dimensional video (such as a reference model) are performed continuously during video capturing of a display target, depth information that is not suitable to be used for the generation of a three-dimensional video may be used in the generation of a three-dimensional video. Examples of depth information that is not suitable to be used in the generation of a three-dimensional video include depth information (current depth information) most recently obtained and being extremely different from previously obtained depth information (previous depth information), depth information determined to include strong noise, current depth information including an object not included in the previous depth information in a comparison between the current depth information and the previous depth information, depth information generated from captured data including an object not supposed to appear, and the like.

In order to solve the problem described above, a video capturing apparatus 60 according to the present embodiment stores depth information and generates a three-dimensional video of a display target with reference to the stored depth information. Embodiment 6 of the present invention as described above will be described below with reference to the drawings.

### Video Capturing System 103

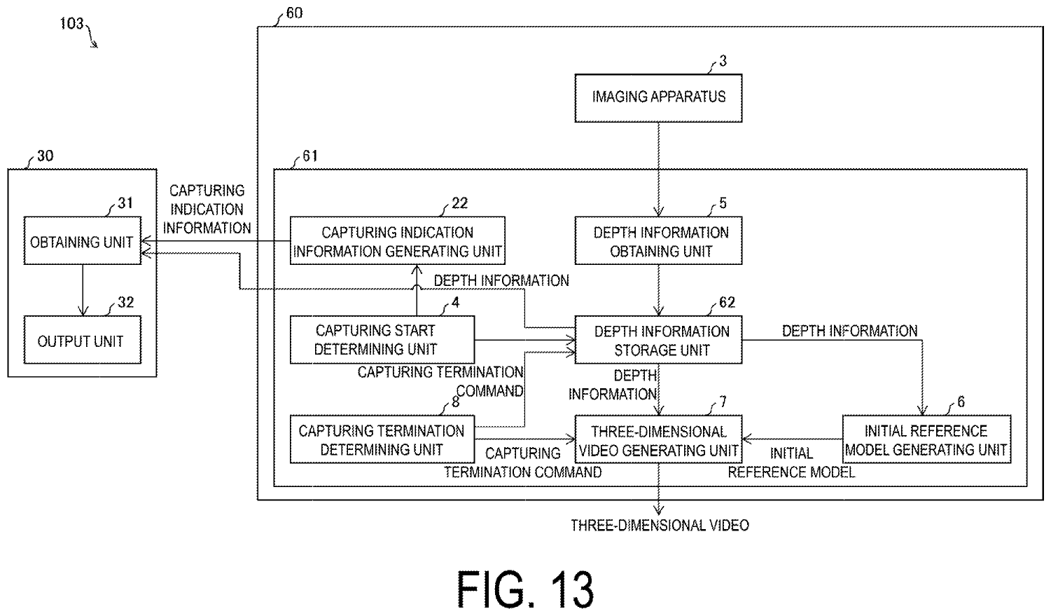

A video capturing system 103 according to the present embodiment will be described with reference to FIG. 13. FIG. 13 is a block diagram illustrating a configuration of the video capturing system 103 according to the present embodiment. As illustrated in FIG. 13, the video capturing system 103 includes a video capturing apparatus 60 and the capturing indication output apparatus 30. The video capturing apparatus 60 includes a video generating apparatus 61 and the imaging apparatus 3. The video generating apparatus 61 has a similar configuration to that of the video generating apparatus 21 according to Embodiment 3 except that the video generating apparatus 61 further includes a depth information storage unit 62. Hence, members having the same functions as the members included in the video capturing system 100 described in Embodiment 3 (including the members included in the video capturing apparatus 1 described in Embodiment 1) are denoted by the same reference signs, and descriptions thereof will be omitted.

The depth information storage unit 62 stores depth information obtained by the depth information obtaining unit 5.

### Video Generation Method

A video generation method of the video capturing system 103 according to the present embodiment will be described. Note that the video generation method of the video capturing system 103 according to the present embodiment is similar to the video generation method according to Embodiment 3 except that a new step is added next to step S33 described in Embodiment 3 and that step S34 is partially different. Hence, detailed descriptions of steps similar to those in the video generation method according to Embodiment 3 are omitted. Note that, in the following, a description will be given of an aspect in which new steps are applied to the process of three-dimensional video generation in step S1 described in Embodiment 1 as the video generation method according to the present embodiment. However, the new steps may be applied to the process of initial reference model generation in step S0 described in Embodiment 1, similarly to Embodiment 3 or Embodiment 4.

In the video generation method according to the present embodiment, as the step next to step S33 described above, the depth information storage unit 62 stores depth information obtained by the depth information obtaining unit 5.

In step S34 described above, the three-dimensional video generating unit 7 generate a three-dimensional video of the display target with reference to the initial reference model read in step S30 and depth information stored in the depth information storage unit 62.

By performing the steps described above, the depth information storage unit 62 can obtain and retain depth information for each time point while the three-dimensional video generating unit 7 does not perform generating of a three-dimensional video during video capturing of the display target by the imaging apparatus 3. Then, after the video capturing of the display target by the imaging apparatus 3 is completed, the three-dimensional video generating unit 7 can generate a three-dimensional video with reference to the depth information stored in the depth information storage unit 62. The output unit 32 of the capturing indication output apparatus 30 may present a list of obtained depth information to the photographer or the imaging object (display target) before the three-dimensional video generating unit 7 generates a three-dimensional video, and to cause the photographer or the imaging object to select depth information to be used for the generation of a reference model. In this case, the three-dimensional video generating unit 7 refers to the selection of depth information by the photographer or the imaging object and generates a three-dimensional video with reference to the selected depth information.

### Supplement

As described above, the video capturing apparatus 60 according to the present embodiment stores depth information and generates a three-dimensional video of a display target with reference to stored depth information.

According to the above-described configuration, by appropriately selecting necessary depth information from among stored depth information and generating a three-dimensional video with reference to the selected depth information, it is possible to generate a suitable three-dimensional video with no missing region. It is also possible to generate a three-dimensional video that does not include an object not supposed to appear.

### Implementation Examples by Software

Control blocks (particularly, the depth information obtaining unit 5, the initial reference model generating unit 6, and the three-dimensional video generating unit 7) of the video generating apparatus 2, the video generating apparatus 11, the video generating apparatus 21, the video generating apparatus 41, the video generating apparatus 51, and the video generating apparatus 61 may be implemented with logic circuits (hardware) formed in an integrated circuit (IC chip) or the like, or may be implemented with software.

In the latter case, the video generating apparatus 2, the video generating apparatus 11, the video generating apparatus 21, the video generating apparatus 41, the video generating apparatus 51, and the video generating apparatus 61 include a computer configured to perform instructions of a program that is software for implementing each function. The computer, for example, includes at least one processor (control device) and includes at least one computer-readable recording medium having the program stored thereon. In the computer, the processor reads from the recording medium and performs the program to achieve the object of the present invention. For example, a Central Processing Unit (CPU) can be used as the processor. As the above-described recording medium, a “non-transitory tangible medium” such as a tape, a disk, a card, a semiconductor memory, and a programmable logic circuit in addition a Read Only Memory (ROM) can be used, for example. A Random Access Memory (RAM) for expanding the program described above may be further included. The above-described program may be supplied to the above-described computer via an arbitrary transmission medium (such as a communication network and a broadcast wave) capable of transmitting the program. Note that one aspect of the present invention may also be implemented in a form of a data signal embedded in a carrier wave in which the program is embodied by electronic transmission.

### Supplement

A video generating apparatus (2, 11, 21, 41, 51, 61) according to aspect 1 of the present invention is a video generating apparatus for generating a three-dimensional video of a display target, and includes a depth information obtaining unit (5) configured to obtain depth information indicating a three-dimensional shape of the display target; and a three-dimensional video generating unit (three-dimensional video generating unit 7) configured to generate the three-dimensional video with reference to the depth information and an initial reference model, which is prepared in advance before a process for generating the three-dimensional video is started and which indicates entirety of the three-dimensional shape of the display target.

According to the above-described configuration, a three-dimensional video is generated with reference to an initial reference model, which is prepared in advance before the process for generating the three-dimensional video is started and which indicates the entire three-dimensional shape of the display target, and hence it is possible to generate a three-dimensional video with no missing region, even immediately after video capturing is started.

A video generating apparatus (2, 11, 21, 41, 51, 61) according to aspect 2 of the present invention may further include, in aspect 1 described above, an initial reference model generating unit (initial reference model generating unit 6) configured to generate the initial reference model with reference to the depth information, and the three-dimensional video generating unit may be configured to generate the three-dimensional video with reference to the initial reference model.

According to the above-described configuration, it is possible to generate an initial reference model in advance in an apparatus for generating a three-dimensional video, and to generate a three-dimensional video with no missing region with reference to the initial reference model.

A video generating apparatus (11) according to aspect 3 of the present invention may further include, in aspect 1 or 2 described above, an initial reference model storage unit (12) configured to store the initial reference model, and the three-dimensional video generating unit may be configured to generate the three-dimensional video with reference to the initial reference model.

According to the above-described configuration, it is possible to generate a three-dimensional video with no missing region with reference to a stored initial reference model.

A video capturing apparatus (1, 10, 20, 40, 50, 60) according to aspect 4 of the present invention includes the video generating apparatus (2, 11, 21, 41, 51, 61) according to any one of aspects 1 to 3 described above, and an imaging apparatus (3) configured to capture the display target and generate the depth information.

According to the above-described configuration, it is possible to generate a three-dimensional video with no missing region with reference to generated depth information.

A video capturing apparatus (40) according to aspect 5 of the present invention may further include, in aspect 4 described above, an initial condition configuring unit (42) configured to configure at least one or more of an initial condition related to start or termination of video capturing of the display target, an initial condition related to obtaining of the depth information, or an initial condition related to generation of the three-dimensional video.

According to the above-described configuration, by appropriately configuring an initial condition(s), it is possible to preferably perform video capturing of a display target, obtaining of depth information, or generation of a three-dimensional video.

A video capturing apparatus (50) according to aspect 6 of the present invention may further include, in aspect 4 or 5 described above, a three-dimensional video checking unit (52) configured to check a state of the three-dimensional video with reference to the three-dimensional video.

According to the above-described configuration, by checking the state of a generated three-dimensional video, it is possible to appropriately exclude a three-dimensional video having a missing region(s).

A video capturing apparatus (60) according to aspect 7 of the present invention may further include, in aspects 4 to 6 described above, a depth information storage unit (62) configured to store the depth information, and the three-dimensional video generating unit may be configured to generate the three-dimensional video with reference to the depth information.

According to the above-described configuration, by appropriately selecting necessary depth information from among stored depth information and generating a three-dimensional video with reference to the selected depth information, it is possible to generate a suitable three-dimensional video with no missing region.

A video capturing apparatus (20, 40, 50, 60) according to aspect 8 of the present invention may further include, in aspects 4 to 7 described above, a capturing indication information generating unit (22) configured to generate capturing indication information related to video capturing of the display target.

According to the configuration described above, it is possible, by providing an indication to a photographer or an imaging object (display target) by appropriately using capturing indication information, to preferably capture the imaging object and is consequently easier to obtain necessary depth information. Hence, a three-dimensional video with no missing region is easily generated.

A video capturing apparatus (20, 40, 50, 60) according to aspect 9 of the present invention may be, in aspect 8 described above, that the capturing indication information generating unit may generate the capturing indication information with reference to at least one or more of the depth information, the initial reference model, or the three-dimensional video.

According to the above-described configuration, it is possible to generate capturing indication information according to a state of a display target, based on at least one or more of the depth information, the initial reference model, and the three-dimensional video.

A video capturing system (100, 101, 102, 103) according to aspect 10 of the present invention includes the video capturing apparatus according to aspect 8 or 9 described above, and a capturing indication output apparatus configured to output an indication related to video capturing of the display target with reference to the capturing indication information.

According to the above-described configuration, it is possible for a photographer or an imaging object (display target) to suitably perform video capturing of the imaging object with reference to an indication output from the capturing indication output apparatus.

A video generation method according to aspect 11 of the present invention is a video generation method for generating a three-dimensional video of a display target, and includes a depth information obtaining step of obtaining depth information indicating a three-dimensional shape of the display target, and a three-dimensional video generating step of generating the three-dimensional video with reference to the depth information and an initial reference model, which is prepared in advance before a process for generating the three-dimensional video is started and which indicates entirety of the three-dimensional shape of the display target.

According to this configuration, similar effects to those of aspect 1 above can be achieved.

The video generating apparatus or the video capturing apparatus according to each of the aspects of the present invention may be implemented by a computer. In this case, a control program of the video generating apparatus configured to cause a computer to operate as each unit (software component) included in the video generating apparatus to implement the video generating apparatus by the computer and a computer-readable recording medium configured to record the control program are also included in the scope of the present invention.

The present invention is not limited to each of the above-described embodiments. It is possible to make various modifications within the scope of the claims. An embodiment obtained by appropriately combining technical elements each disclosed in different embodiments falls also within the technical scope of the present invention. Further, combining technical elements disclosed in the respective embodiments makes it possible to form a new technical feature.

### CROSS-REFERENCE OF RELATED APPLICATION

This application claims the benefit of priority to IP 2017-186852 filed on Sep. 27, 2017, which is incorporated herein by reference in its entirety.

### REFERENCE SIGNS LIST

1, 10, 20, 40, 50, 60 Video capturing apparatus
2, 11, 21, 41, 51, 61 Video generating apparatus
3 Imaging apparatus
4 Capturing start determining unit
5 Depth information obtaining unit
6 Initial reference model generating unit
7 Three-dimensional video generating unit
8 Capturing termination determining unit
12 Initial reference model storage unit
22 Capturing indication information generating unit
30 Capturing indication output apparatus
31 Obtaining unit
32 Output unit
42 Initial condition configuring unit
52 Three-dimensional video checking unit
62 Depth information storage unit
100, 101, 102, 103 Video capturing system

1. A video capturing apparatus for capturing a three-dimensional video of a display target, the video capturing apparatus comprising:
an imaging circuitry that generates depth information indicating a three-dimensional shape of the display target;
a three-dimensional video generating circuitry that generates the three-dimensional video with reference to the depth information and an initial reference model which the three-dimensional shape of the display target; and
a capturing indication information generating circuitry that generates capturing indication information related to video capturing of the display target.

2. The video capturing apparatus according to claim 1, further comprising an initial reference model generating circuitry that generates the initial reference model with reference to the depth information.

3. The video capturing apparatus according to claim 1, further comprising
an initial reference model storage circuitry that stores the initial reference model.

4. (canceled)

5. The video capturing apparatus according to claim 1, further comprising
an initial condition configuring circuitry that sets at least one or more of an initial condition related to start or termination of video capturing of the display target, an initial condition related to obtaining of the depth information, or an initial condition related to generation of the three-dimensional video.

6. The video capturing apparatus according to claim 14, further comprising
a three-dimensional video checking circuitry that checks a state of the three-dimensional video with reference to the three-dimensional video.

7. The video capturing apparatus according to claim 1, further comprising
a depth information storage circuitry that stores the depth information.

8. (Canceled)

9. The video capturing apparatus according to claim 1, wherein the capturing indication information generating circuitry generates the capturing indication information with reference to at least one or more of the depth information, the initial reference model, and the three-dimensional video.

10. A video capturing system comprising:
the video capturing apparatus according to claim 1; and
a capturing indication output apparatus configured to output an indication related to video capturing of the display target with reference to the capturing indication information.

11. A video capturing method for capturing a three-dimensional video of a display target, the video capturing method comprising:
generating depth information indicating a three-dimensional shape of the display target;
generating the three-dimensional video with reference to the depth information and an initial reference model which indicates entirety of the three-dimensional shape of the display target; and
generating capturing indication information related to video capturing of the display target.

12-13. (canceled)
